(19) United States
(12) Patent Application Publication
(10) Pub. No.: US 2026/0211193 A1
(43) Pub. Date: Jul. 23, 2026

(54) AUGMENTED REALITY DISPLAY WITH FREEFORM OPTICS AND INTEGRATED PRESCRIPTION LENS

(71) Applicant: GOOGLE LLC, Mountain View, CA (US)

(72) Inventors: Yi Qin, Mountain View, CA (US); Oscar Alberto Martinez, San Diego, CA (US)

(21) Appl. No.: 19/140,297

(22) PCT Filed: Jan. 10, 2024
(86) PCT No.: PCT/US2024/011041

§ 371 Date: Jun. 17, 2025

Related U.S. Application Data
(60) Provisional application No. 63/438,812, filed on Jan. 13, 2023.

(51) Int. Cl. G02B 6/42; G02B 27/01

(52) U.S. Cl. CPC G02B 6/4203; G02B 27/0172; G02B 2027/0178

(57) ABSTRACT

A dual-component lightguide employs two freeform surfaces separated by a gap with prescription lens integration. A world-side component includes a spherical world-side surface and a freeform eye-side surface. An eye-side component includes a freeform world-side surface that conforms to the freeform eye-side surface of the world-side component and an eye-side surface that is shaped to provide corrective optics based on a desired prescription.

### BACKGROUND

Wearable electronic eyewear devices include optical systems that magnify a display image and deliver a virtual image into the field of view (FOV) of a user. In some cases, wearable electronic eyewear devices also allow the user to see the outside world through a lens or see-through eyepiece. Some wearable electronic eyewear devices incorporate a near-to-eye optical system to display content to the user. For example, some eyewear display designs include a micro-display (“display”) positioned in a temple or rim region of a head wearable frame like a conventional pair of eyeglasses. The display generates images, such as computer-generated images (CGI), that are conveyed into the FOV of the user by optical elements such as curved lightguides deployed in the lens (or “optical combiner”) of the head wearable display frame. The wearable electronic eyewear device can therefore serve as a hardware platform for implementing augmented reality (AR) or mixed reality (MR). Different modes of augmented reality include optical see-through augmented reality, video see-through augmented reality, or opaque (VR) modes.

### BRIEF SUMMARY OF EMBODIMENTS

In a first embodiment, an eyewear display system includes a lightguide. The lightguide includes a first component comprising a world-side surface and a freeform eye-side surface, a second component comprising a freeform world-side surface and an eye-side surface shaped to impart corrective optics based on a desired prescription, and a gap between the first component and the second component.

The freeform world-side surface of the second component conforms to the freeform eye-side surface of the first component in some embodiments. The gap may be filled with air or a low-index coating.

In some embodiments, the eyewear display system further includes a frame comprising a temple portion and a brow portion, a micro-display to project display light, an incoupler at a proximal end of the lightguide to couple the display light into the lightguide, and an outcoupler at a distal end of the lightguide to couple at least a portion of the display light out of the lightguide.

In some embodiments, display light coupled into the lightguide undergoes three bounces of total internal reflection within the first component before being coupled out of the lightguide, wherein the micro-display is positioned within either the temple portion or the brow portion. In other embodiments, display light coupled into the lightguide undergoes two bounces of total internal reflection within the first component before being coupled out of the lightguide, wherein the micro-display is positioned within the brow portion of the frame. In some embodiments, display light coupled into the lightguide undergoes four bounces of total internal reflection within the first component before being coupled out of the lightguide, wherein the micro-display is positioned within the temple portion of the frame.

In another embodiment, a method includes receiving ambient light at a spherical world-side surface of a world-side component of a lightguide of an eyewear display system, coupling light generated at a micro-display into the world-side component of the lightguide, the lightguide having a freeform eye-side surface separated from a freeform world-side surface of an eye-side component of the lightguide by a gap, to direct the light generated at the micro-display through the world-side component of the lightguide via total internal reflection, and transmitting through an eye-side surface of the eye-side component of the lightguide light outcoupled from the lightguide via an outcoupler and ambient light received at the spherical world-side surface, wherein the eye-side surface of the eye-side component of the lightguide is shaped to apply corrective optics based on a desired prescription.

The freeform world-side surface of the eye-side component conforms to the freeform eye-side surface of the world-side component in some embodiments. The gap may be filled with air or a low-index coating.

In some embodiments, the method further includes coupling display light from a micro-display into the lightguide through an incoupler at a proximal end of the lightguide, and coupling at least a portion of the display light out of the lightguide through an outcoupler at a distal end of the lightguide.

Display light coupled into the lightguide may undergo three bounces of total internal reflection within the world-side component before being coupled out of the lightguide, wherein the micro-display is positioned within either a temple portion or a brow portion of a frame of the eyewear display system. In other embodiments, display light coupled into the lightguide undergoes two bounces of total internal reflection within the world-side component before being coupled out of the lightguide, wherein the micro-display is positioned within a brow portion of a frame of the eyewear display system. In some embodiments, display light coupled into the lightguide undergoes four bounces of total internal reflection within the world-side component before being coupled out of the lightguide, wherein the micro-display is positioned within a temple portion of a frame of the eyewear display system.

In another embodiment, a lightguide includes a world-side component comprising a spherical world-side surface and a freeform eye-side surface, and an eye-side component comprising a freeform world-side surface and an eye-side surface shaped to apply corrective optics based on a desired prescription, wherein the freeform eye-side surface of the world-side component and the freeform world-side surface of the eye-side component are separated by a gap.

The freeform world-side surface of the eye-side component conforms to the freeform eye-side surface of the world-side component in some embodiments. The gap may be filled with air or a low-index coating.

In some embodiments, the lightguide further includes a frame comprising a temple portion and a brow portion, a micro-display to project display light, an incoupler at a proximal end of the lightguide to couple the display light into the lightguide, and an outcoupler at a distal end of the lightguide to couple at least a portion of the display light out of the lightguide.

In some embodiments, display light coupled into the lightguide undergoes three bounces of total internal reflection within the world-side component before being coupled out of the lightguide, wherein the micro-display is positioned within either the temple portion or the brow portion. In other embodiments, display light coupled into the lightguide undergoes two bounces of total internal reflection within the world-side component before being coupled out of the lightguide, wherein the micro-display is positioned within the brow portion of the frame. In some embodiments, display light coupled into the lightguide undergoes four bounces of total internal reflection within the world-side component before being coupled out of the lightguide, wherein the micro-display is positioned within the temple portion of the frame.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display system employing a dual-component lightguide having multiple freeform surfaces separated by a gap and an integrated prescription lens in accordance with some embodiments.

FIG. 2 is a diagram illustrating a dual-component lightguide receiving display light from a temple-mounted micro-display at an incoupler and directing the light out of the lightguide through an eye-side surface of an eye-side component after interactions with a freeform eye-side surface of a world-side component and an outcoupler in accordance with some embodiments.

FIG. 3 shows an example eyewear display system employing a temple-mounted micro-display in accordance with some embodiments.

FIG. 4 shows a display image as projected by a temple-mounted micro-display and as affected by optics of a dual-component lightguide in accordance with some embodiments.

FIG. 5 is a diagram illustrating a dual-component lightguide receiving display light from a brow-mounted micro-display at an incoupler and directing the light out of the lightguide through an eye-side surface of an eye-side component after interactions with a freeform eye-side surface of a world-side component and an outcoupler in accordance with some embodiments.

FIG. 6 shows example eyewear display systems employing a brow-mounted micro-display in accordance with some embodiments.

FIG. 7 shows display images as projected by a brow-mounted micro-display and as affected by optics of a two-component lightguide in accordance with some embodiments.

FIG. 8 is a flow diagram of a method for guiding display light through a dual-component lightguide in accordance with some embodiments.

### DETAILED DESCRIPTION

Eyewear display systems potentially have multiple practical and leisure applications, but the development and adoption of wearable electronic display devices have been limited by constraints imposed by the optics, aesthetics, manufacturing process, thickness, field of view (FOV), and prescription lens limitations of the optical systems used to implement existing display devices. For example, the geometry and physical constraints of conventional designs result in displays having relatively small FOVs and relatively thick optical combiners.

The optical performance of an eyewear display system is an important factor in its design; however, users also care significantly about aesthetics of wearable devices. Independent of their performance limitations, many of the conventional examples of eyewear display systems have struggled to find traction in consumer markets because, at least in part, they lack fashion appeal. Some eyewear display systems employ planar lightguides in planar transparent combiners and, as a result, appear very bulky and unnatural on a user's face compared to the sleeker and more streamlined look of typical curved eyeglass and sunglass lenses. Thus, it is desirable to integrate curved lenses with lightguides in wearable heads-up displays or eyewear in order to achieve the form factor and fashion appeal expected of the eyeglass and sunglass frame industry. Some eyewear display systems employ freeform lightguides and prisms; however, the optical performance and eyebox size of the lightguides are limited by the number of degrees of freedom in the freeform surfaces and the number of freeform surfaces. Furthermore, adding a prescription lens increases the thickness of the lens assembly.

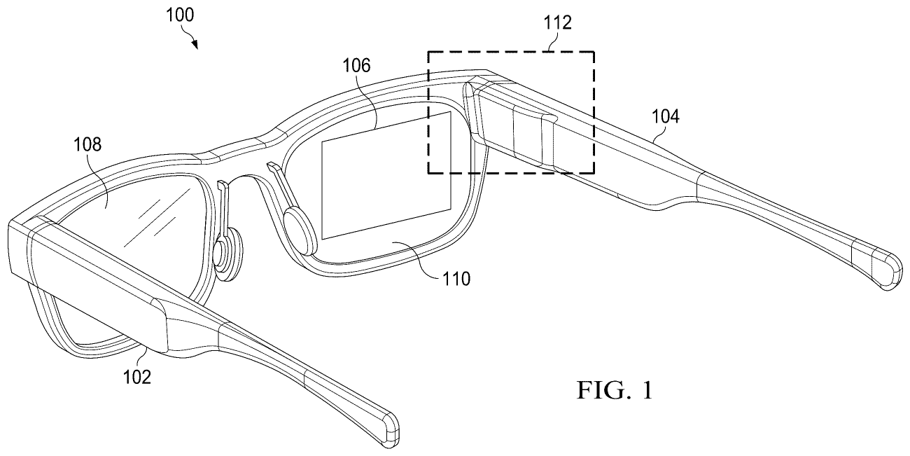

FIGS. 1-8 illustrate a dual-component lightguide that employs two freeform surfaces separated by a gap with prescription lens integration to achieve a relatively large eyebox, high optical display performance, and low distortion for display light and transmission of ambient light from the environment in a thin form factor. The lightguide includes two components, and each of the freeform surfaces is on a separate component of the lightguide. A world-side component includes a spherical world-side surface, a freeform eye-side surface, and a display-side freeform surface. An eye-side component includes a freeform world-side surface and an eye-side surface that is shaped to provide corrective optics based on a desired prescription. Thus, the eye-side surface of the eye-side component is spherical in some embodiments and freeform in other embodiments, depending on the desired prescription.

The freeform eye-side surface of the world-side component and the freeform world-side surface of the eye-side component conform to each other and are separated by a gap having a relatively low refractive index. In some embodiments, the gap is an air gap formed with glass beads. In other embodiments, the gap is filled with a low-index material such as a low-index coating having a refractive index of less than approximately 1.3. The difference in refractive index between the world-side component and the gap causes total internal reflection (TIR) of light impinging on the freeform eye-side surface of the world-side component at a minimum angle of incidence. In some embodiments, the minimum angle of incidence is greater than approximately 38 degrees, depending on the refractive index of the lightguide. At the same time, the spherical world-side surface of the world-side component and the eye-side surface of the eye-side component transmit ambient light from the environment through the lightguide while applying a desired optical power.

The freeform eye-side surface of the world-side component and the freeform world-side surface of the eye-side component conform to each other in some implementations and provide an additional degree of freedom that reduces abberations, reduces distortion, and saves computation power to correct such distortions. The combination of the two freeform surfaces provides a sharp display with high contrast and enlarges the eyebox due to the additional degree of freedom. The larger eyebox enables the display to be visible at a larger variety of eye positions and accommodates users having varying inter-pupillary distances.

The total thickness of the dual-component lightguide is less than approximately 6 mm in some embodiments while producing a FOV of up to 25 degrees. In addition, the architecture of the dual-component lightguide can provide a larger FOV with increasing thickness of the dual-component lightguide. For example, a 10 mm thick dual-component lightguide can provide a FOV of approximately 50 degrees without a field lens. Thus, both ambient light from the environment and display light directed through the lightguide and having an enlarged FOV are directed to an eye of a user with an integrated prescription lens. The dual-component lightguide can be implemented in a variety of eyewear display systems, including those with an eyeglass form factor. The term “freeform” refers to a surface that does not have symmetry around any axis.

FIG. 1 illustrates an example near-eye display system 100 (referred to as display system 100) employing a dual-component lightguide with multiple freeform surfaces providing an enlarged field of view and prescription corrective lensing in accordance with some embodiments. The display system 100 has a support structure 102 that includes an arm 104, which houses a micro-display such as a micro-LED or micro-LCD display in some embodiments. The micro-display is configured to project display light toward the eye of a user via a lightguide, such that the user perceives projected images as being displayed in a field of view (FOV) area 106 of a display at one or both of spherical lens elements 108, 110. In some embodiments, the micro-display is housed within a brow portion of the support structure 102. In the depicted embodiment, the display system 100 is a near-eye display system in the form of eyewear display system in which the support structure 102 is configured to be worn on the head of a user and has a general shape and appearance (that is, form factor) of an eyeglasses (e.g., sunglasses) frame.

The support structure 102 contains or otherwise includes various components to facilitate the projection of such images toward the eye of the user, such as a micro-display and a lightguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1. It should be understood that instances of the term “or” herein refer to the non-exclusive definition of “or”, unless noted otherwise. For example, herein the phrase “X or Y” means “either X, or Y, or both”.

One or both of the spherical lens elements 108, 110 are used by the display system 100 to provide an augmented reality (AR) display in which rendered graphical content can be superimposed over or otherwise provided in conjunction with a real-world view as perceived by the user through the spherical lens elements 108, 110. For example, a micro-display of the display system 100 uses light to form a perceptible image or series of images by projecting the light onto the eye of the user via a dual-component lightguide formed at least partially in the corresponding spherical lens element 108 or 110, according to various embodiments.

One or both of the spherical lens elements 108, 110 includes at least a portion of a dual-component lightguide that routes display light received by an incoupler of the lightguide to an outcoupler of the lightguide, which outputs the display light toward an eye of a user of the display system 100. The display light is magnified and collimated onto the eye of the user such that the user perceives the display light as an image. In addition, each of the spherical lens elements 108, 110 is sufficiently transparent to allow a user to see through the spherical lens elements to provide a field of view of the user's real-world environment such that the image appears superimposed over at least a portion of the real-world environment.

In some embodiments, a display panel of the micro-display is configured to output light (representing an image or portion of an image for display) into the dual-component lightguide of the display system. The dual-component lightguide expands the light and outputs the light toward the eye of the user via an outcoupler.

The micro-display is communicatively coupled to the controller and a non-transitory processor-readable storage medium or memory storing processor-executable instructions and other data that, when executed by the controller, cause the controller to control the operation of the micro-display. In some embodiments, the controller controls the micro-display to selectively set the location and size of the FOV area 106. In some embodiments, the controller is communicatively coupled to one or more processors (not shown) that generate content to be displayed at the display system 100. The micro-display outputs light toward the FOV area 106 of the display system 100 via the dual-component lightguide.

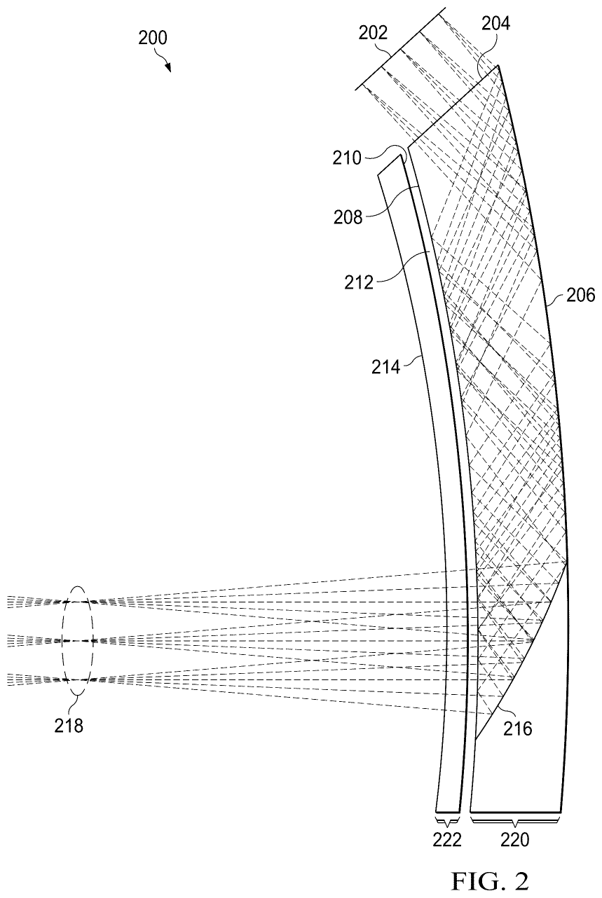

FIG. 2 is a diagram illustrating a dual-component lightguide 200 receiving display light from a temple-mounted micro-display 202 at an incoupler 204 and directing the light out of the lightguide 200 through an eye-side surface 214 of an eye-side component 222 after interactions with a freeform eye-side surface 208 of a world-side component 220 and an outcoupling surface referred to as outcoupler 216 in accordance with some embodiments. In some embodiments, the dual-component lightguide 200 is implemented in a wearable heads-up display or other display system, such as the eyewear display system 100 of FIG. 1.

The dual-component lightguide 200 includes a first (world-side) component 220 with a world-side surface 206 that is spherical in some embodiments and a freeform eye-side surface 208, a second (eye-side) component 222 with a freeform world-side surface 210 and an eye-side surface 214 shaped to impart a desired optical power, and a gap 212 between the first and second components 220, 222 in accordance with some embodiments. In some embodiments, the world-side surface 206 of the first component 220 is aspherical. The freeform eye-side surface 208 of the world-side component 220 and the freeform world-side surface 210 of the eye-side component 222 have shapes that conform to each other and are separated by the gap 212. In some embodiments, the freeform eye-side surface 208 of the world-side component 220 and the freeform world-side surface 210 of the eye-side component 222 have approximately the same prescription, such that ambient light passing through both freeform surfaces 208, 210 is minimally distorted by optical aberrations. At the same time, the two freeform surfaces 208, 210 provide additional degrees of freedom to correct optical aberrations for the optical path of display light through the dual-component lightguide 200. In some embodiments, the freeform surfaces 208, 210 are non-rotationally symmetric surfaces such as XY polynomials. In some embodiments, the gap 212 is maintained by glass beads (not shown) and is filled with air. In other embodiments, the gap 212 is filled with a low-index coating (not shown), having an index of refraction of approximately 1.1.

The term “lightguide,” as used herein, refers to a combiner using one or more of total internal reflection (TIR), specialized filters, or reflective surfaces, to transfer light generated by a micro-display from an incoupler to an outcoupler. In some display applications, light entering the incoupler is a cone, and interactions with the optical surfaces of the lightguide convert the cone into collimated light (i.e., parallel rays) so that it appears to a user as if the light originated at a distance in front of the user. In the present example, the light received at the incoupler is relayed to the outcoupler via the lightguide using TIR. In general, the terms “incoupler” and “outcoupler” will be understood to refer to any type of optical grating structure, including, but not limited to, refractive or reflective freeform surfaces, diffraction gratings, holograms, holographic optical elements (e.g., optical elements using one or more holograms), volume diffraction gratings, volume holograms, surface relief diffraction gratings, or surface relief holograms. The incoupler and outcoupler may be spherical, planar, or freeform in various embodiments. In some embodiments, the outcoupler is a partial mirror. The display light is then output to the eye of a user via the outcoupler. As described above, in some embodiments the dual-component lightguide 200 is implemented as part of an eyeglass lens, such as the lens 108 or lens 110 (FIG. 1) of the display system having an eyeglass form factor.

The interface of the freeform eye-side surface 208 of the world-side component 220 and the air or low-index material that separates the freeform eye-side surface 208 of the world-side component 220 from the freeform world-side surface 210 of the eye-side component 222 causes light to experience TIR between the freeform eye-side surface 208 of the world-side component 220 and the spherical world-side surface 206 of the world-side component 220 when the light impinges on the freeform eye-side surface 208 at an angle of at least approximately 38 degrees, depending on the refractive index of the lightguide 200. In some embodiments, the low-index material has a refractive index of approximately n=1.1.

In the illustrated example, light incoupled via the incoupler 204 undergoes four instances of TIR (four bounces) within the world-side component 220 before impinging on the outcoupler 216. In some embodiments, the outcoupler 216 is coated with a partial mirror coating. Following TIR within the world-side component 220 of the lightguide 200, the light is then output to an exit pupil 218 where it can be received at the eye (not shown) of a user via the outcoupler 216 and the prescription lens freeform (or, in other embodiments, spherical) eye-side surface 214 of the eye-side component 222. In some embodiments, a dual-component lightguide 200 having a thickness of 6 mm to 10 mm provides a FOV of 25 degrees to 50 degrees without the use of any field elements. By adding a field lens (not shown), the FOV can be further increased, and the eyebox, modulation transfer function (MTF), and other display quality metrics can also be further improved.

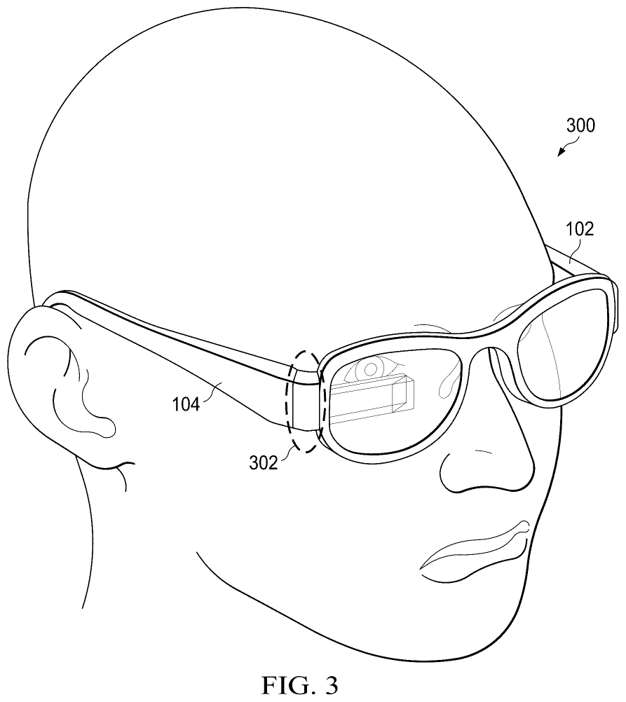

FIG. 3 shows an example eyewear display system 300 employing a temple-mounted micro-display 302 in accordance with some embodiments. In the illustrated embodiment, the micro-display 302 is mounted in a temple portion of the arm 104 of the support structure 102 of an eyewear display system such as eyewear display system 100 of FIG. 1. In some embodiments, a dual-component lightguide such as dual-component lightguide 200 is incorporated in the eyewear display system 300 to receive light emitted from the micro-display 302.

For a temple-mounted micro-display 302, in some embodiments the dual-component lightguide 200 accommodates four TIR bounces of display light within the world-side component 220 before impinging on the outcoupler 216 to be transmitted to the eye-side component 222 toward an exit pupil 218 for receipt at an eye of a user. In some embodiments, the total thickness of the dual-component lightguide 200 is less than approximately 6 mm and provides a FOV of up to approximately 25 degrees with a display size of approximately 0.1 to 0.4 inches. The additional degree of freedom afforded by the two conforming freeform surfaces 208, 210 is used to correct optical aberrations and reduce display distortion for the dual-component lightguide 200. In some embodiments, the amount of distortion is less than approximately 5%. By minimizing distortion, the dual-component lightguide 200 conserves computational power of the eyewear display system 300, as less power is required to correct distortions.

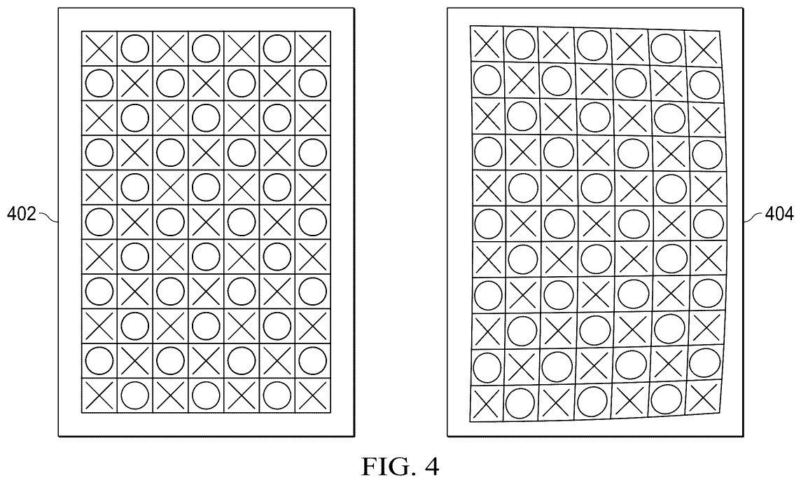

FIG. 4 shows a display image 402 as projected by a temple-mounted micro-display and a display image 404 as affected by optics of a dual-component lightguide without digital correction in accordance with some embodiments. In particular, the eye-side surface of the eye-side component is either spherical or freeform, depending on a desired prescription. In embodiments in which corrective optics are desired, the eye-side surface of the eye-side component is freeform. The combination of the spherical world-side surface of the world-side component and the eye-side surface of the eye-side component imparts the corrective optics for the desired prescription, as shown in display image 404, without the need for an additional prescription insert. Accordingly, embodiments incorporating an aspherical eye-side surface of the eye-side component allow for corrective optics while eliminating any additional weight and thickness of a prescription insert. By contrast, in embodiments in which no prescription is desired, the eye-side surface of the eye-side component of the dual-component lightguide is spherical. The combination of a spherical eye-side surface of the eye-side component with the spherical world-side surface of the world-side component imparts no corrective optics, as shown in display image 402.

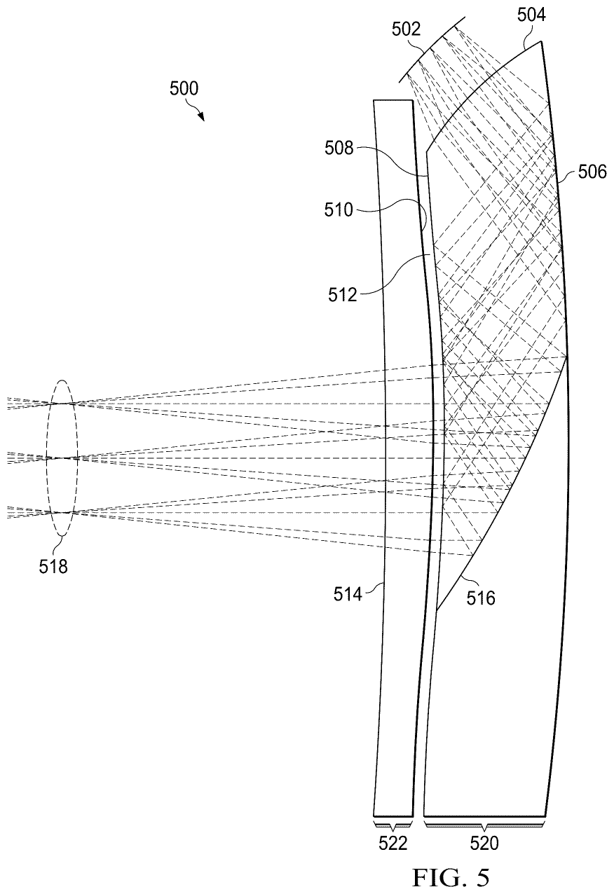

FIG. 5 is a diagram illustrating a dual-component lightguide 500 receiving display light from a brow-mounted micro-display 502 at an incoupler 504 and directing the light out of the lightguide 500 through an eye-side surface 514 of an eye-side component 522 after interactions with a freeform eye-side surface 508 of a world-side component 520 and an outcoupler 516 in accordance with some embodiments.

Similar to the dual-component lightguide 200 of FIG. 2, the dual-component lightguide 500 includes a first (world-side) component 520 with a spherical world-side surface 506 and a freeform eye-side surface 508, a second (eye-side) component 522 with a freeform world-side surface 510 and an eye-side surface 514 shaped to impart a desired optical power, and a gap 512 between the first and second components 520, 522 in accordance with some embodiments. The freeform eye-side surface 508 of the world-side component 520 and the freeform world-side surface 510 of the eye-side component 522 have shapes that conform to each other and are separated by the gap 512. In some embodiments, the gap 512 is maintained by glass beads (not shown) and is filled with air. In other embodiments, the gap 512 is filled with a low-index coating, having an index of refraction of approximately 1.1.

In the illustrated example, light incoupled via the incoupler 504 undergoes two instances of TIR (two bounces) within the world-side component 520 before impinging on the outcoupler 516. Following TIR within the world-side component 520 of the lightguide 500, the light is then output to an exit pupil 518 for receipt at an eye (not shown) of a user via the outcoupler 516 and the prescription lens freeform eye-side surface 514 of the eye-side component 522. In some embodiments, the FOV of the lightguide 500 is 25 degrees without the use of any field elements.

In some embodiments, light incoupled via the incoupler 504 undergoes three instances of TIR (three bounces) within the world-side component 520 of the dual-component lightguide 500 before impinging on the outcoupler 516. Such embodiments can be employed with either a temple-mounted or brow-mounted micro-display 502.

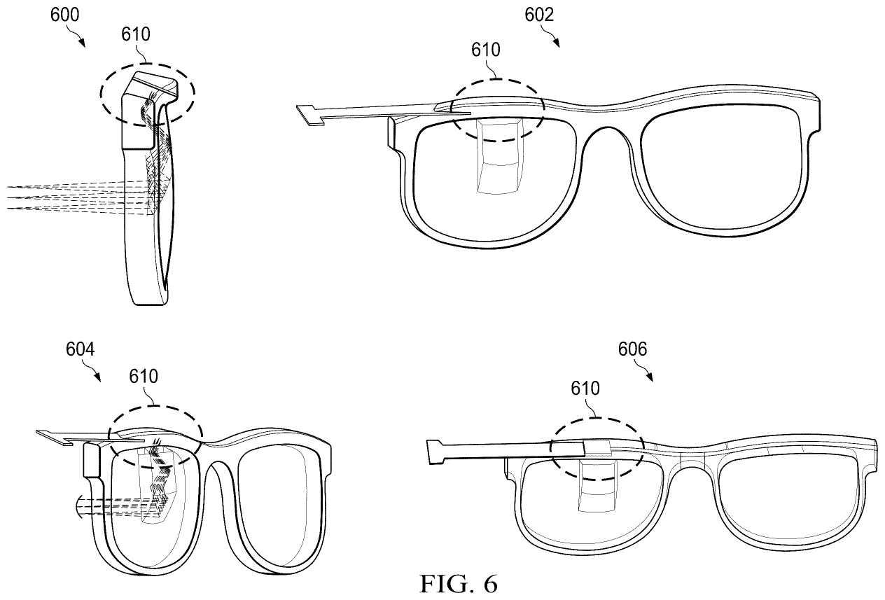

FIG. 6 shows example eyewear display systems 600, 602, 604, 606 employing a brow-mounted micro-display in accordance with some embodiments. In the illustrated embodiments, a micro-display 610 is mounted in a brow portion of the arm 104 of the support structure 102 of an eyewear display system such as eyewear display system 100 of FIG. 1. In some embodiments, a dual-component lightguide such as dual-component lightguide 500 is incorporated in the eyewear display systems 600, 602, 604, 606 to receive light emitted from the micro-display 602.

For a brow-mounted micro-display 602, in some embodiments the dual-component lightguide 500 accommodates two TIR bounces of display light within the world-side component 520 before impinging on the outcoupler 516 to be transmitted to the eye-side component 522 toward an exit pupil 518 for receipt at an eye of a user. In some embodiments, the total thickness of the dual-component lightguide 500 is less than approximately 6 mm and provides a FOV of up to approximately 25 degrees with a display size of approximately 0.1 to 0.3 inches. Similar to the dual-component lightguide 200, the additional degree of freedom afforded by the two conforming freeform surfaces 508, 510 is used to correct optical aberrations and reduce display distortion for the dual-component lightguide 500. In some embodiments, the amount of distortion is less than approximately 5%. By minimizing distortion, the dual-component lightguide 500 conserves computational power of the eyewear display systems 600, 602, 604, 606, as less power is required to correct distortions.

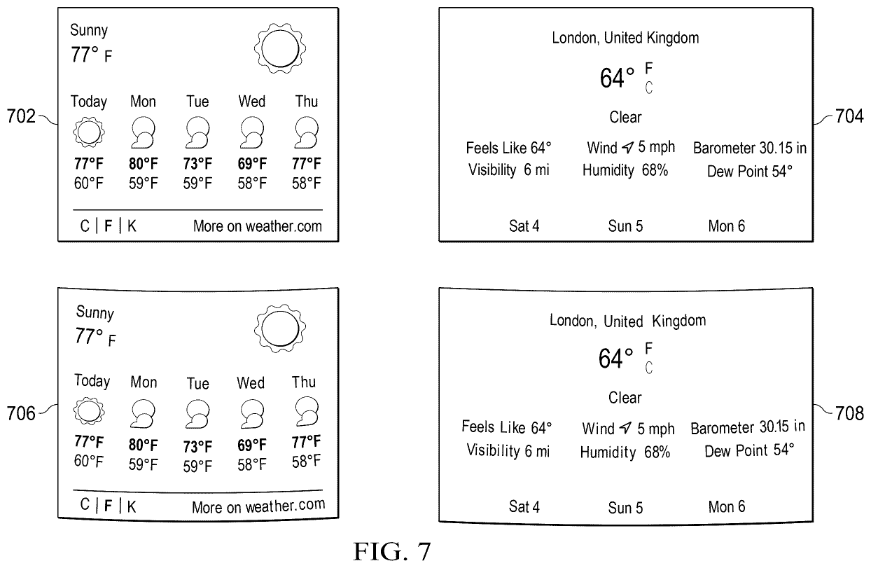

FIG. 7 shows display images 702, 704 as projected by a brow-mounted micro-display and display images 706, 708 as affected by optics of a dual-component lightguide with integrated prescription lens in accordance with some embodiments. In embodiments in which corrective optics are desired, the eye-side surface of the eye-side component is freeform. The combination of the spherical world-side surface of the world-side component and the eye-side surface of the eye-side component imparts the corrective optics for the desired prescription, as shown in display images 706, 708, without the need for an additional prescription insert. Accordingly, embodiments incorporating an aspherical eye-side surface of the eye-side component allow for corrective optics while eliminating any additional weight and thickness of a prescription insert. By contrast, in embodiments in which no prescription is desired, the eye-side surface of the eye-side component of the dual-component lightguide is spherical. The combination of a spherical eye-side surface of the eye-side component with the spherical world-side surface of the world-side component imparts no corrective optics, as shown in display images 702, 704.

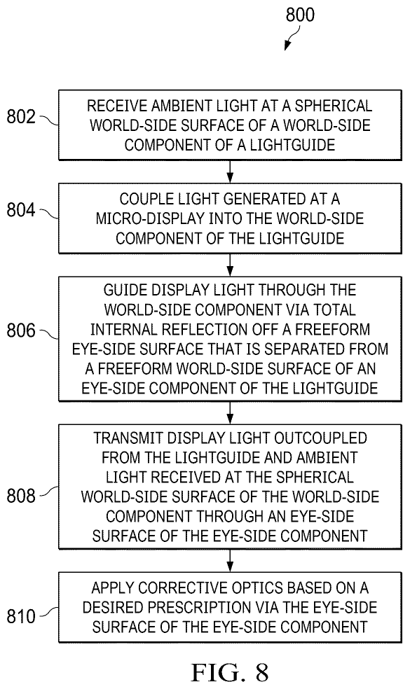

FIG. 8 is a flow diagram of a method 800 for guiding display light through a dual-component lightguide in accordance with some embodiments. In some embodiments, the method is implemented in an eyewear display device such as eyewear display devices 100, 300, or 600 using a dual-component lightguide such as dual-component lightguides 200 or 500.

At block 802, the dual-component lightguide 200, 500 receives ambient light at the spherical world-side surface of the world-side component 220, 520. At block 804, the incoupler 204, 504 couples display light projected from a micro-display 202, 502 into the world-side component 220, 520 of the dual-component lightguide 200, 500. In some embodiments, the micro-display 202 is mounted to a temple portion of the eyewear display device 100, 300. In other embodiments, the micro-display 502 is mounted to a brow portion of the eyewear display device 100, 600.

At block 806, the world-side component 220, 520 guides display light via total internal reflection off the freeform eye-side surface 208, 508 and the spherical world-side surface 206, 506. The freeform eye-side surface 208, 508 of the world-side component 220, 520 is separated from the freeform world-side surface 210, 510 of the eye-side component 222, 522 by a gap 212, 512. In some embodiments, the gap 212, 512 is filled with air and the separation between the freeform eye-side surface 208, 508 of the world-side component 220, 520 and the freeform world-side surface 210, 510 of the eye-side component 222, 522 is maintained with beads made of glass or another low refractive index material. In other embodiments, the gap 212, 512 is filled with a low-index coating (e.g., a coating material having a refractive index of approximately 1.1).

At block 808, the outcoupler 216, 516 transmits at least a portion of the display light out of the world-side component 220, 520 and through the eye-side component 222, 522. In some embodiments, the outcoupler is coated with a partially reflective mirror coating. At the same time, ambient light received at the spherical world-side surface 206, 506 of the world-side component 220, 520 is transmitted through the world-side component 220, 520, across the gap 212, 512, and through the eye-side component 222, 522.

At block 810, the eye-side surface 214, 514 applies corrective optics based on a desired prescription to both the ambient light and the display light that is guided through the eye-side component 222, 522 toward an exit pupil 218, 518 for receipt at a user's eye.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An eyewear display system, comprising:
a lightguide comprising:
a first component comprising a world-side surface and a freeform eye-side surface;
a second component comprising a freeform world-side surface and an eye-side surface shaped to impart corrective optics based on a desired prescription; and
a gap between the first component and the second component.

2. The eyewear display system of claim 1, wherein the freeform world-side surface of the second component conforms to the freeform eye-side surface of the first component.

3. The eyewear display system of claim 1, wherein the gap comprises air or a low-index coating.

4. The eyewear display system of claim 1, further comprising:
a frame comprising a temple portion and a brow portion;
a micro-display to project display light;
an incoupler at a proximal end of the lightguide to couple the display light into the lightguide; and
an outcoupler at a distal end of the lightguide to couple at least a portion of the display light out of the lightguide.

5. The eyewear display system of claim 4, wherein display light coupled into the lightguide undergoes three bounces of total internal reflection within the first component before being coupled out of the lightguide, wherein the micro-display is positioned within either the temple portion or the brow portion.

6. The eyewear display system of claim 4, wherein display light coupled into the lightguide undergoes two bounces of total internal reflection within the first component before being coupled out of the lightguide, wherein the micro-display is positioned within the brow portion of the frame.

7. The eyewear display system of claim 4, wherein display light coupled into the lightguide undergoes four bounces of total internal reflection within the first component before being coupled out of the lightguide, wherein the micro-display is positioned within the temple portion of the frame.

8. A method comprising:
receiving ambient light at a spherical world-side surface of a world-side component of a lightguide of an eyewear display system;
coupling light generated at a micro-display into the world-side component of the lightguide, the lightguide having a freeform eye-side surface separated from a freeform world-side surface of an eye-side component of the lightguide by a gap, to direct the light generated at the micro-display through the world-side component of the lightguide via total internal reflection; and
transmitting through an eye-side surface of the eye-side component of the lightguide light outcoupled from the lightguide via an outcoupler and ambient light received at the spherical world-side surface, wherein the eye-side surface of the eye-side component of the lightguide is shaped to apply corrective optics based on a desired prescription.

9. The method of claim 8, wherein the freeform world-side surface of the eye-side component conforms to the freeform eye-side surface of the world-side component.

10. The method of claim 8, wherein the gap comprises air or a low-index coating.

11. The method of claim 8, further comprising:
coupling display light from a micro-display into the lightguide through an incoupler at a proximal end of the lightguide; and
coupling at least a portion of the display light out of the lightguide through an outcoupler at a distal end of the lightguide.

12. The method of claim 11, wherein display light coupled into the lightguide undergoes three bounces of total internal reflection within the world-side component before being coupled out of the lightguide, wherein the micro-display is positioned within either a temple portion or a brow portion of a frame of the eyewear display system.

13. The method of claim 11, wherein display light coupled into the lightguide undergoes two bounces of total internal reflection within the world-side component before being coupled out of the lightguide, wherein the micro-display is positioned within a brow portion of a frame of the eyewear display system.

14. The method of claim 11, wherein display light coupled into the lightguide undergoes four bounces of total internal reflection within the world-side component before being coupled out of the lightguide, wherein the micro-display is positioned within a temple portion of a frame of the eyewear display system.

15. A lightguide, comprising:
a world-side component comprising a spherical world-side surface and a freeform eye-side surface; and
an eye-side component comprising a freeform world-side surface and an eye-side surface shaped to apply corrective optics based on a desired prescription, wherein the freeform eye-side surface of the world-side component and the freeform world-side surface of the eye-side component are separated by a gap.

16. The lightguide of claim 15, wherein the freeform world-side surface of the eye-side component conforms to the freeform eye-side surface of the world-side component.

17. The lightguide of claim 15, wherein the gap comprises air or a low-index coating.

18. The lightguide of claim 15, further comprising:
a frame comprising a temple portion and a brow portion;
a micro-display to project display light;
an incoupler at a proximal end of the lightguide to couple the display light into the lightguide; and
an outcoupler at a distal end of the lightguide to couple at least a portion of the display light out of the lightguide.

19. The lightguide of claim 18, wherein display light coupled into the lightguide undergoes three bounces of total internal reflection within the world-side component before being coupled out of the lightguide, wherein the micro-display is positioned within either the temple portion or the brow portion.

20. The lightguide of claim 18, wherein display light coupled into the lightguide undergoes two bounces of total internal reflection within the world-side component before being coupled out of the lightguide, wherein the micro-display is positioned within the brow portion of the frame.

21. The lightguide of claim 18, wherein display light coupled into the lightguide undergoes four bounces of total internal reflection within the world-side component before being coupled out of the lightguide, wherein the micro-display is positioned within the temple portion of the frame.
